(19) United States
(12) Patent Application Publication
(10) Pub. No.: US 2015/0039632 A1
(43) Pub. Date: Feb. 5, 2015

(54) Media Tagging

(71) Applicant: Nokia Corporation, Espoo (FI)

(72) Inventors: Jussi Leppanen, Tampere (FI); Igor Curcio, Tampere (FI); Antti Eronen, Tampere (FI); Ole Kirkeby, Espoo (FI)

(73) Assignee: Nokia Corporation, Espoo (FI)

(21) Appl. No.: 14/379,870

(22) PCT Filed: Feb. 27, 2012
(86) PCT No.: PCT/FI2012/050197

§ 371 Date: Oct. 7, 2014

(51) Int. Cl. G06F 17/30; G06K 9/62

(52) U.S. Cl. CPC G06F 17/30247; G06K 9/6201
USPC 707/748; 707/736

(57) ABSTRACT

The invention relates to media tagging of a media content. At least one media tag is determined on the basis of obtained context recognition data formed prior to and after a time point of capturing of the media content. Determined at least one media tag is associated with said media content.

### TECHNICAL FIELD

The present application relates generally to media tagging.

### BACKGROUND

Current electronic user devices, such as smart phones and computers, carry a plurality of functionalities, for example various programs for different needs and different modules for photographing, positioning, sensing, communication and entertainment. As electronic devices develop they are used more and more for recording users' lives as image, audio, video, 3D video or any other media that can be captured by electronic devices. Recorded media may be stored, for example, in online content warehouses, from where searching and browsing of it should be somehow possible afterwards.

Most searches are done via textual queries; thus, there must be a mechanism to link applicable keywords or phrases to media content. There exist programs for automatic context recognition that can be used to create search queries for media content, i.e. to perform media tagging. Media tagging may be done based on the user's context environment or activity etc. However, the tagging is often incorrect. The state of the user as well as the situation where the media is captured may be incorrectly defined, which leads to incorrect tagging. Incorrect tagging may prevent the finding of the media content later on by textual search, but it may also give misleading information about media.

### SUMMARY OF THE INVENTION

Now there has been invented an improved method and technical equipment implementing the method. Various aspects of the invention include a method, an apparatus, a system and a computer program, which are characterized by what is stated in the independent claims. Various aspects of examples of the invention are set out in the claims.

According to a first aspect there is provided a method, comprising obtaining a first context recognition data and a second context recognition data, wherein said first context recognition data and said second context recognition data relate to a media content, and wherein said first context recognition data is formed prior to a time point of capturing of said media content and said second context recognition data is formed after the time point of capturing of said media content, determining a media tag on the basis of at least said first context recognition data and said second context recognition data and associating said media tag with said media content.

According to an embodiment, said first context recognition data comprise at least first type of context tags that are obtained from a context source point prior to capturing of said media content. According to an embodiment, said second context recognition data comprise at least first type of context tags that are obtained from a context source after capturing of said media content. According to an embodiment, said first and second context recognition data comprise at least first and second types of context tags that are obtained from different context sources prior to capturing of said media content. According to an embodiment, said first and second context recognition data comprise at least first and second types of context tags that are obtained from different context sources after capturing of said media content. According to an embodiment, first type of context tags are obtained at at least one time point prior to capturing of said media content. According to an embodiment, first type of context tags are obtained at at least one time point after capturing of said media content. According to an embodiment, first type of context tags are obtained at a span prior to capturing of said media content. According to an embodiment, first type of context tags are obtained at a span after capturing of said media content. According to an embodiment, obtained context tags are formed into words. According to an embodiment, said media tag is determined by choosing the most common context tag in said first and second context recognition data. According to an embodiment, said media tag is determined by choosing the context tag from first and second context recognition data that is obtained from context source at the time point that is closest to the time point of capturing of said media content. According to an embodiment, said media tag is determined on the basis of weighting of context tags. According to an embodiment, said weighting is done by assigning a weight for a context tag on the basis of distance of a time point of obtaining said context tag from the time point of capturing of said media content. According to an embodiment, said media tag is determined on the basis of telescopic tagging.

According to a second aspect there is provided an apparatus comprising at least one processor, at least one memory including computer program code for one or more program units, the at least one memory and the computer program code configured to, with the processor, cause the apparatus to perform at least the following: obtaining first context recognition data and second context recognition data, wherein said first context recognition data and said second context recognition data relate to a media content, and wherein said first context recognition data is formed prior to a time point of capturing of said media content and said second context recognition data is formed after the time point of capturing of said media content, determining a media tag on the basis of at least said first context recognition data and said second context recognition data, and associating said media tag with said media content.

According to an embodiment, said first context recognition data comprise at least first type of context tags that are obtained from a context source point prior to capturing of said media content. According to an embodiment, said second context recognition data comprise at least first type of context tags that are obtained from a context source after capturing of said media content. According to an embodiment, said first and second context recognition data comprise at least first and second types of context tags that are obtained from different context sources prior to capturing of said media content. According to an embodiment, said first and second context recognition data comprise at least first and second types of context tags that are obtained from different context sources after capturing of said media content. According to an embodiment, first type of context tags are obtained at at least one time point prior to capturing of said media content. According to an embodiment, first type of context tags are obtained at at least one time point after capturing of said media content. According to an embodiment, first type of context tags are obtained at a span prior to capturing of said media content. According to an embodiment, first type of context tags are obtained at a span after capturing of said media content. According to an embodiment, obtained context tags are formed into words. According to an embodiment, said media tag is determined by choosing the most common context tag in said first and second context recognition data. According to an embodiment, said media tag is determined by choosing the context tag from first and second context recognition data that is obtained from context source at the time point that is closest to the time point of capturing of said media content. According to an embodiment, said media tag is determined on the basis of weighting of context tags. According to an embodiment, said weighting is done by assigning a weight for a context tag on the basis of distance of a time point of obtaining said context tag from the time point of capturing of said media content. According to an embodiment, said media tag is determined on the basis of telescopic tagging. According to an embodiment, the apparatus comprises a communication device comprising a user interface circuitry and user interface software configured to facilitate a user to control at least one function of the communication device through use of a display and further configured to respond to user inputs and a display circuitry configured to display at least a portion of a user interface of the communication device, the display and display circuitry configured to facilitate the user to control at least one function of the communication device. According to an embodiment, said communication device comprises a mobile phone.

According to a third aspect there is provided a system comprising at least one processor, at least one memory including computer program code for one or more program units, the at least one memory and the computer program code configured to, with the processor, cause the system to perform at least the following: obtaining first context recognition data and second context recognition data, wherein said first context recognition data and said second context recognition data relate to a media content, and wherein said first context recognition data is formed prior to a time point of capturing of said media content and said second context recognition data is formed after the time point of capturing of said media content, determining a media tag on the basis of at least said first context recognition data and said second context recognition data, and associating said media tag with said media content.

According to an embodiment, said first context recognition data comprise at least first type of context tags that are obtained from a context source point prior to capturing of said media content. According to an embodiment, said second context recognition data comprise at least first type of context tags that are obtained from a context source after capturing of said media content. According to an embodiment, said first and second context recognition data comprise at least first and second types of context tags that are obtained from different context sources prior to capturing of said media content. According to an embodiment, said first and second context recognition data comprise at least first and second types of context tags that are obtained from different context sources after capturing of said media content. According to an embodiment, first type of context tags are obtained at at least one time point prior to capturing of said media content. According to an embodiment, first type of context tags are obtained at at least one time point after capturing of said media content. According to an embodiment, first type of context tags are obtained at a span prior to capturing of said media content. According to an embodiment, first type of context tags are obtained at a span after capturing of said media content. According to an embodiment, obtained context tags are formed into words. According to an embodiment, said media tag is determined by choosing the most common context tag in said first and second context recognition data. According to an embodiment, said media tag is determined by choosing the context tag from first and second context recognition data that is obtained from context source at the time point that is closest to the time point of capturing of said media content. According to an embodiment, said media tag is determined on the basis of weighting of context tags. According to an embodiment, said weighting is done by assigning a weight for a context tag on the basis of distance of a time point of obtaining said context tag from the time point of capturing of said media content. According to an embodiment, said media tag is determined on the basis of telescopic tagging.

According to a fourth aspect there is provided a computer program comprising one or more instructions which, when executed by one or more processors, cause an apparatus to perform: obtaining a first context recognition data and a second context recognition data, wherein said first context recognition data and said second context recognition data relate to a media content, and wherein said first context recognition data is formed prior to a time point of capturing of said media content and said second context recognition data is formed after the time point of capturing of said media content, determining a media tag on the basis of at least said first context recognition data and said second context recognition data, and associating said media tag with said media content.

According to an embodiment, said first context recognition data comprise at least first type of context tags that are obtained from a context source point prior to capturing of said media content. According to an embodiment, said second context recognition data comprise at least first type of context tags that are obtained from a context source after capturing of said media content. According to an embodiment, said first and second context recognition data comprise at least first and second types of context tags that are obtained from different context sources prior to capturing of said media content. According to an embodiment, said first and second context recognition data comprise at least first and second types of context tags that are obtained from different context sources after capturing of said media content. According to an embodiment, first type of context tags are obtained at at least one time point prior to capturing of said media content. According to an embodiment, first type of context tags are obtained at at least one time point after capturing of said media content. According to an embodiment, first type of context tags are obtained at a span prior to capturing of said media content. According to an embodiment, first type of context tags are obtained at a span after capturing of said media content. According to an embodiment, obtained context tags are formed into words. According to an embodiment, said media tag is determined by choosing the most common context tag in said first and second context recognition data. According to an embodiment, said media tag is determined by choosing the context tag from first and second context recognition data that is obtained from context source at the time point that is closest to the time point of capturing of said media content. According to an embodiment, said media tag is determined on the basis of weighting of context tags. According to an embodiment, said weighting is done by assigning a weight for a context tag on the basis of distance of a time point of obtaining said context tag from the time point of capturing of said media content. According to an embodiment, said media tag is determined on the basis of telescopic tagging.

According to a fifth aspect there is provided an apparatus, comprising means for obtaining first context recognition data and second context recognition data, wherein said first context recognition data and said second context recognition data relate to a media content, and wherein said first context recognition data is formed prior to a time point of capturing of said media content and said second context recognition data is formed after the time point of capturing of said media content, means for determining a media tag on the basis of at least said first context recognition data and said second context recognition data, and means for associating said media tag with said media content.

### BRIEF DESCRIPTION OF THE DRAWINGS

For a more complete understanding of example embodiments of the present invention, reference is now made to the following descriptions taken in connection with the accompanying drawings in which:

FIG. 1 shows a flow chart of a method for determining a media tag according to an embodiment;

FIG. 2a shows a system and devices for determining a media tag according to an embodiment;

FIG. 3 shows blocks of a system for determining a media tag for media content according to an embodiment;

FIG. 4 shows an example of an operations model of an automatic media tagging system according to an embodiment;

FIG. 5 shows a smart phone displaying context tags according to an embodiment;

FIG. 6 shows a media content with determined media tags according to an embodiment; and

FIG. 7 shows an apparatus for implementing embodiments of the invention according to an embodiment.

### DETAILED DESCRIPTION

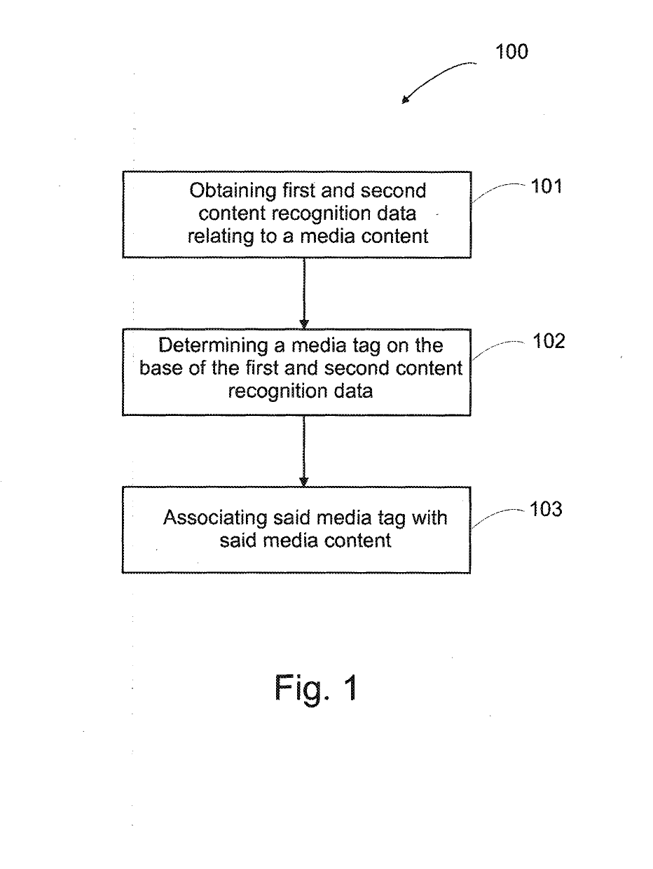

An example embodiment of the present invention and its potential advantages are understood by referring to FIGS. 1 through 6 of the drawings.

FIG. 1 shows a flow chart of a method for determining a media tag 100 according to an embodiment. In phase 110, in an embodiment both first context recognition data and second context recognition data are obtained. First and second context recognition data relate to a media content that may be captured by the same device that obtains first and second context recognition data or by a different device. First context recognition data are formed prior to capturing of the media content and second context recognition data are formed after capturing of the media content. Forming of context recognition data may mean, for example, that context tags are obtained, collected, from sensors or applications. Context tags may be collected at one time point prior to and after the media content capture, or context tags may be collected at more than one point prior to and after the media content capture.

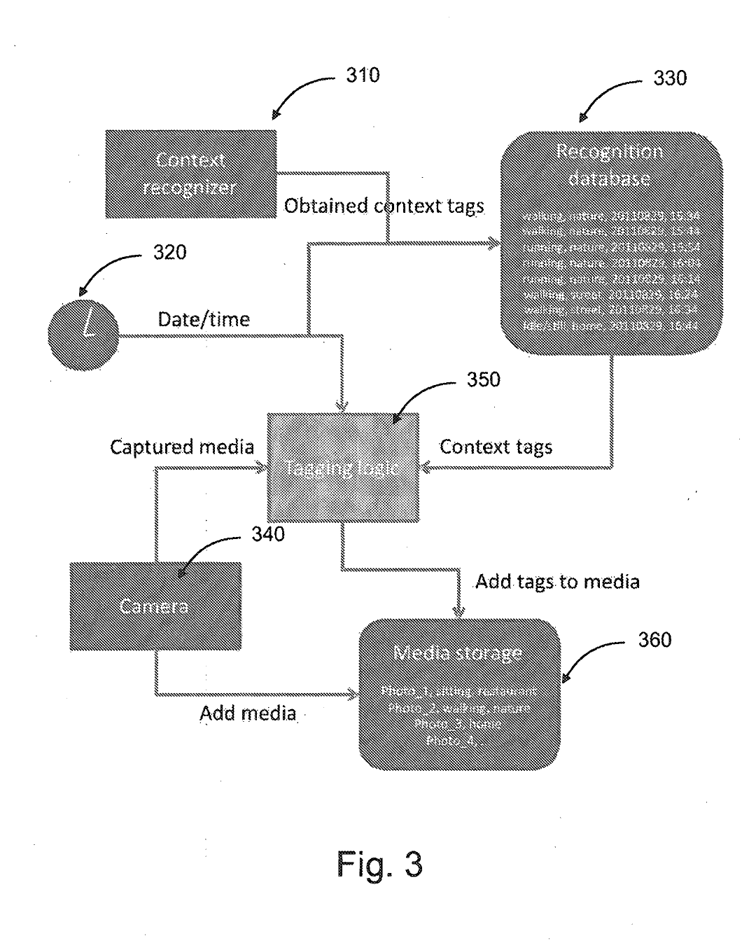

On the basis of first context recognition data and second context recognition data, in phase 120, the media tag may be determined. Several possible determinations are proposed in context with FIG. 3. In phase 130, after determination of the media tag, the media tag may be associated with said media content.

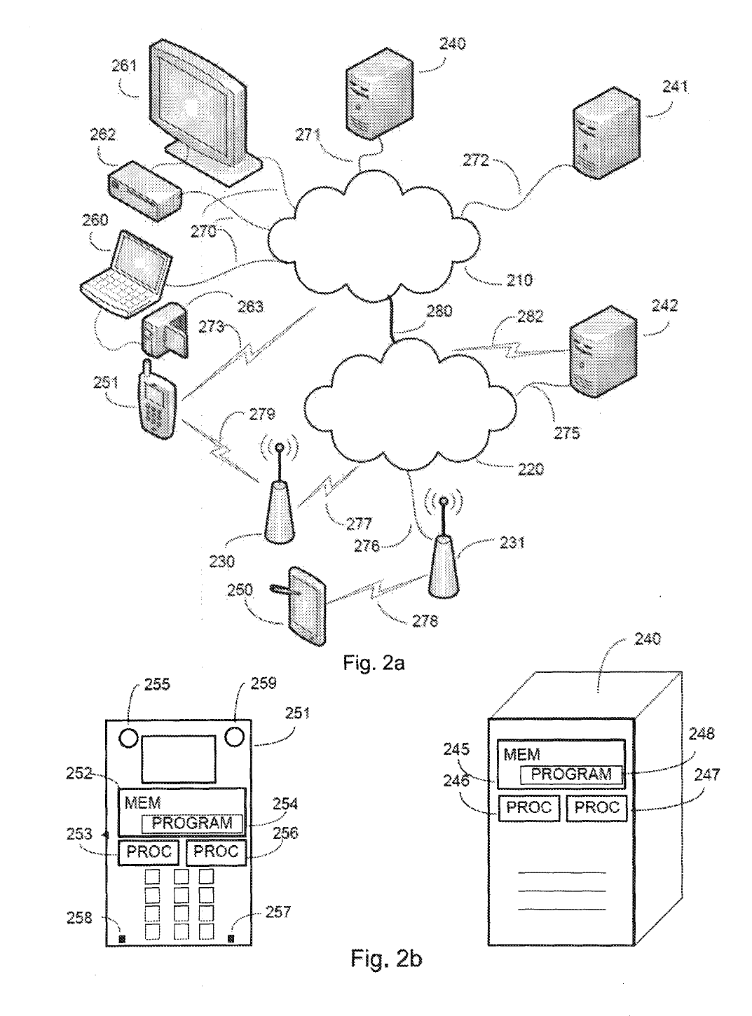

FIGS. 2a and 2b show a system and devices for determining a media tag (metadata) for a media content i.e. media tagging according to an embodiment. The context recognition may be done in a single device, in a plurality of devices connected to each other, or e.g. in a network service framework with one or more servers and one or more user devices.

In FIG. 2a, the different devices may be connected via a fixed network 210, such as the Internet or a local area network, or a mobile communication network 220, such as the Global System for Mobile communications (GSM) network, 3rd Generation (3G) network, 3.5th Generation (3.5G) network, 4th Generation (4G) network, Wireless Local Area Network (WLAN), Bluetooth®, or other contemporary and future networks. Different networks are connected to each other by means of a communication interface 280. The networks comprise network elements, such as routers and switches to handle data (not shown), and communication interfaces, such as the base stations 230 and 231 in order to provide access to the network for the different devices, and the base stations 230, 231 are themselves connected to the mobile network 220 via a fixed connection 276 or a wireless connection 277.

There may be a number of servers connected to the network, and in the example of FIG. 2a are shown a server 240 for providing a network service, such as a social media service and connected to the fixed network 210, a server 241 for providing a network service, and connected to the fixed network 210, and a server 242 for providing a network service and connected to the mobile network 220. Some of the above devices, for example the servers 240, 241, 242 may be such that they make up the Internet with the communication elements residing in the fixed network 210.

There are also a number of end-user devices, such as mobile phones and smart phones 251, Internet access devices (Internet tablets) 250, personal computers 260 of various sizes and formats, televisions and other viewing devices 261, video decoders and players 262, as well as video cameras 263 and other encoders, such as digital microphones for audio capture. These devices 250, 251, 260, 261, 262 and 263 can also be made of multiple parts. The various devices may be connected to the networks 210 and 220 via communication connections, such as a fixed connection 270, 271, 272 and 280 to the internet, a wireless connection 273 to the internet 210, a fixed connection 275 to the mobile network 220, and a wireless connection 278, 279 and 282 to the mobile network 220. The connections 271-282 are implemented by means of communication interfaces at the respective ends of the communication connection.

FIG. 2b shows devices where determining of a media tag for media content may be carried out according to an example embodiment. As shown in FIG. 2b, the server 240 contains memory 245, one or more processors 246, 247, and computer program code 248 residing in the memory 245 for implementing, for example, the functionalities of a software application like a social media service. The different servers 240, 241, 242 may contain at least these same elements for employing functionality relevant to each server. Similarly, the end-user device 251 contains memory 252, at least one processor 253 and 256, and computer program code 254 residing in the memory 252 for implementing, for example, the functionalities of a software application like a browser or a user interface of an operating system. The end-user device may also have one or more cameras 255 and 259 for capturing image data, for example video. The end-user device may also contain one, two or more microphones 257 and 258 for capturing sound. The end-user devices may also have one or more wireless or wired microphones attached thereto. The different end-user devices 250, 260 may contain at least these same elements for employing functionality relevant to each device. The end user devices may also comprise a screen for viewing a graphical user interface.

It needs to be understood that different embodiments allow different parts to be carried out in different elements. For example, execution of a software application may be carried out entirely in one user device, such as 250, 251 or 260, or in one server device 240, 241, or 242, or across multiple user devices 250, 251, 260 or across multiple network devices 240, 241, or 242, or across both user devices 250, 251, 260 and network devices 240, 241, or 242. For example, the capturing of user input through a user interface may take place in one device, the data processing and providing information to the user may take place in another device and the determining of media tag may be carried out in a third device. The different application elements and libraries may be implemented as a software component residing in one device or distributed across several devices, as mentioned above, for example so that the devices form a so-called cloud. A user device 250, 251 or 260 may also act as web service server, just as the various network devices 240, 241 and 242. The functions of this web service server may be distributed across multiple devices, too.

The different embodiments may be implemented as software running on mobile devices and on devices offering network-based services. The mobile devices may be equipped with at least a memory or multiple memories, one or more processors, display, keypad, camera, video camera, motion detector hardware, sensors such as accelerometer, compass, gyroscope, light sensor etc. and communication means, such as 2G, 3G, WLAN, or other. The different devices may have hardware, such as a touch screen (single-touch or multi-touch) and means for positioning, such as network positioning, for example, WLAN positioning system module, or a global positioning system (GPS) module. There may be various applications on the devices such as a calendar application, a contacts application, a map application, a messaging application, a browser application, a gallery application, a video player application and various other applications for office and/or private use.

FIG. 3 shows blocks of a system for determining a media tag for media content according to an embodiment. The system (not shown) may be, for example, a smart phone, tablet, computer, personal digital assistants (PDAs), pagers, mobile televisions, mobile telephones, gaming devices, laptop computers, tablet computers, personal computers (PCs), cameras, camera phones, video recorders, audio/video players, radios, global positioning system (GPS) devices, any combination of the aforementioned or any other means suitable to be used in this context. A context recognizer 310 provides the system with user's context recognition data. The context recognition data comprises context tags from a plurality of different context sources, such as applications like a clock 320 (time), global positioning system (GPS) (location information), WLAN positioning system (hotel, restaurant, pub, home), calendar (date), and/or other devices around the system and its user, and/or sensors, such as thermometer, ambient light sensor, compass, gyroscope, and acceleration sensor (warm, light, still). Context tags indicate activity, environment, location, time etc. of the user by words from the group of common words, brand names, words in internet addresses and states from a sensor or application formed into words. Different types of context tags are obtained from different context sources. The context recognizer 310 may be run periodically, providing context recognition data i.e. context tags at set predetermined intervals, for example, once every 10 minutes, 30 minutes or hour. The length of intervals is not restricted; it can be selected by the user of the electronic device or it can be predetermined for or by the system. The context recognizer 310 may also be run when triggered by an event. One possible triggering event may be a physical movement of the device, which movement signal may be captured by one of the sensors in the device i.e. the context recognizer 310 may start providing context recognition data i.e. context tags only after the user is picking the device from his/her pocket or from a table. Other possible triggering events may be, for example, change in light, temperature or any other change in the user state arranged to act as a trigger event.

When user moves from one activity to another, the context tags may change due to a change in the context recognition data that is available. Some context information may be available at some time and not available at other times. That is, the availability of context recognition data may vary over time.

The context recognition data along with a time stamp may be stored in a recognition database 330 of the system. The context recognition data in the recognition database 330 may comprise context tags obtained in different time points.

Once the user captures media content, for example, takes a picture or video by a camera 340, the camera software may indicate to a tagging logic software 350 that media content has been captured i.e. recorded. The captured media content may also be stored in the memory of the system (Media storage 360). The system may contain memory, one or more processors, and computer program code residing in the memory for implementing the functionalities of the tagging logic software.

Once the camera 340 informs the tagging logic software 350 that media content has been captured, the recognition database 330 is queried for context recognition data stored in the database 330 prior to the capture of the media content. The logic software 350 may then wait for further context information data comprising context tags from at least one later time point than media capture to appear in the database 330. It is also possible to wait for context recognition data longer, for example, context tags from 2, 3, 4, 5 or more further time points after the media capture.

Once further context recognition data are available, the logic 350 may determine the most suitable media tag/tags based on the context recognition data obtained prior to and after the media capture to be added for the captured media content. The media tag/tags may be placed into the metadata field of the captured media content or otherwise associated with the captured media. Later on, the added media tag/tags may be used for searching of stored media contents. The choosing of most suitable media tags for captured media content may be done in several ways in the tagging logic 350. Some of the possible ways are explained below.

The length of a span of the context recognition data, which is used for determining the media tag prior to and after media capture is not restricted. The span can be, for example, predefined for the system. It may be, for example, 10 minutes, 30 minutes, an hour or an even longer time period. One possible span may start, for example, 30 minutes before a media content capture and end 30 minutes after the capture of the media content. It is also possible to define the span on the basis of an amount of time points for obtaining context tags, for example, 5 time points prior to and after media capture.

One possible way to determine a media tag for a media content is to choose the most common context tag in context recognition data during a span prior to and after a media capture.

Another possible way to determine a media tag for a media content is to choose the context tag from context recognition data that is formed i.e. obtained from a context source at the time point that is closest to the time point of media capturing.

Another possible way is to weight context tags observed before and after the capture so that weight gets smaller as the distance from the media capture time point increases. The most weighted context tag/tags may be determined for media tag/tags for a media content in question.

It is possible to weight context tags. For example, assuming the system collects N times tags prior to capturing the media content and N times after capturing the media content, the weights could be assigned as follows. For example, when N=2, the weights become, w(−2)=0.1111, w(−1)=0.2222, w(0)=0.3333, w(2)=0.2222, and w(1)=0.1111. The final weights for context tags are obtained by summing the weights across all tags with the same label. For example, if w(−2)=‘car’ and w(2)=‘car’, then the final weight for context tag ‘car’=0.4444. In the above weighting scheme, the weights decrease linearly when going farther away from the media capture situation. In addition, it is also possible to make the weights decrease nonlinearly. For example, in one embodiment the weights could follow a Gaussian curve centered at the media capture situation (point 0). In these cases, it may be advantageous to normalize the weights so that they add up to one. This can also be omitted. The distances between the time points of collecting tags may then be calculated in various ways. For example, the dot product, correlation, Euclidean distance, document distance metrics, such as term-frequency inverse-document-frequency weighting, or probabilistic “distances”, such as the Kullback-Leibler divergence may be used.

Another possible way is to store the complete ordered sequence of context tags and apply some kind of distortion measure between the context tag sequences. For example, the system may store the sequence Car-Walk-Bar-PHOTO TAKING-Car-Home for a first media file. For a second media file, the sequence may be Car-Walk-Restaurant-PHOTO TAKING-Car-Home. If we denote a=“Car”, b=“Walk”, c=“Bar”, d=“Home”, and e=“Restaurant”, the sequences for these media files would become ‘abcad’ and ‘abead’. These can be interpreted as text strings, and for example the edit distance could be used for calculating a distance between the strings ‘abcad’ and ‘abead’.

Another possible way is to use telescopic tagging. In telescopic tagging, if the sequence of context tags for a user is, for example, Restaurant-Walk-Bar-Walk-MEDIA CAPTURE-Walk-Metro-Home, then a question to be answered is: “what was the user doing before or after the media capture?”. The answer is “the user was in the Bar XYZ” and then “took the metro at Paddington St”. These context tags with lower weight are the ones that help reconstructing the user's memory around the MEDIA CAPTURE event. The telescopic nature is given by the fact that the memory may be flexibly extended or compressed in the past and/or the future from the instant of the media capture time based on the user's wish. The final tag i.e. media tag may therefore be a vector of context tags that extends in the past or future from the time the media was captured. This vector may be associated to the media.

In an embodiment, the telescopic tagging may be a functionality that can be visible for a user in the user interface of the device, for example, in the smart phone or tablet. For example, the telescopic tagging may be enabled or disabled by the user. In addition, there may be two parameter options, for example, Past_Time and Future_Time, which could be chosen by the user to indicate how far in the past or in the future the long-term context tagging i.e. collecting of context recognition data must operate. There may further be two additional parameters Past_Time_Sharing and Future_Time_Sharing indicating the same as the above Past_Time and Future_Time parameters with the difference that the latter parameters may be used when sharing the media content with others after re-tagging it. For example, a user might want to retain a picture tagged with a long-term context of 3 hours in the past for him/herself, but share with others the same picture tagged with a long term context of only 10 minutes in the past, or even with no long-term context at all. Therefore, when the picture is wanted to be shared, or transmitted, copied, etc., the picture may be automatically re-tagged using the sharing parameters. Alternatively, the user may be prompted for confirming the temporal length of the long term tagging.

According to another embodiment of this invention, the telescopic tagging and its vector of context tags and the above parameters may also be used for searching media in a database. For example, it may be possible to search all the pictures with long-term past context=“Restaurant”+“Walk”+“Bar”. The search engine would then return all the pictures shot by a user who was in a restaurant, then walking, and then in a bar just before taking the pictures.

In another embodiment, the vector of context tags and the above parameters may be transmitted to other users or to a server using any networking technology, such as Bluetooth, WLAN, 3G/4G, and using any suitable protocol at any of the ISO OSI protocol stack layers, such as HTTP for performing cross-searches between users, or searches in a social service (“search on all my friends' profiles”).

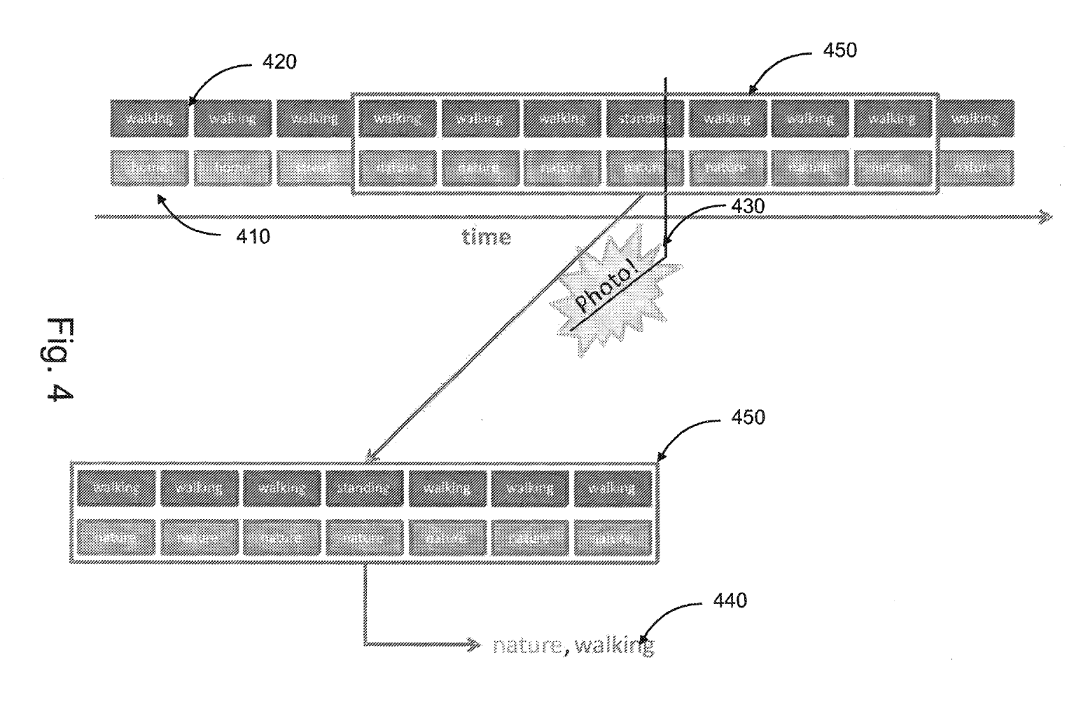

FIG. 4 shows an example of an operations model of an automatic media tagging system according to an embodiment. In this example, a user is walking in the woods. During the walking the system does periodic context recognitions for environment and activity of the user, for example, every 10 minutes. The system stores into its memory environment context tags 410 and activity context tags 420 as context recognition data. User stops to take a photo and continues on his walk at indicated time point 430. After obtaining enough context recognition data, for example, predetermined span of 30 minutes prior to and after photo taking, the tagging system determines that user was taking a walk in nature and tags the photo with the media tags, ‘walking’ and ‘nature’ 440. These media tags to be associated with a photo are determined from context recognition data 30 minutes before and after photo taking. The window for context tags used for determining of the media tags is indicated by a context recognition window 450.

However, if the tagging system uses only the context tags at the time point of capture 430 to media tag the photo, the system does not determine a walking tag, but it will media tag the photo ‘standing’ and ‘nature’. This may lead into problems afterwards, since the user or any other person can't find that photo by text queries ‘walking’ and ‘nature’, which were the right media tags for the photo taking situation since the photo was taken on the walk.

The number of media tags to be associated with a photo is not restricted. There may be several media tags or only, for example, one, two or three media tags. The number of associated media tags may depend, for example, on the number of collected i.e. obtained types of context recognition tags. Environment, activity, location are examples of context tags types. In addition, for example, for a video, it is possible to add media tags along the video i.e. the video content may comprise more than one media capture time points for which media tag/tags may be determined.

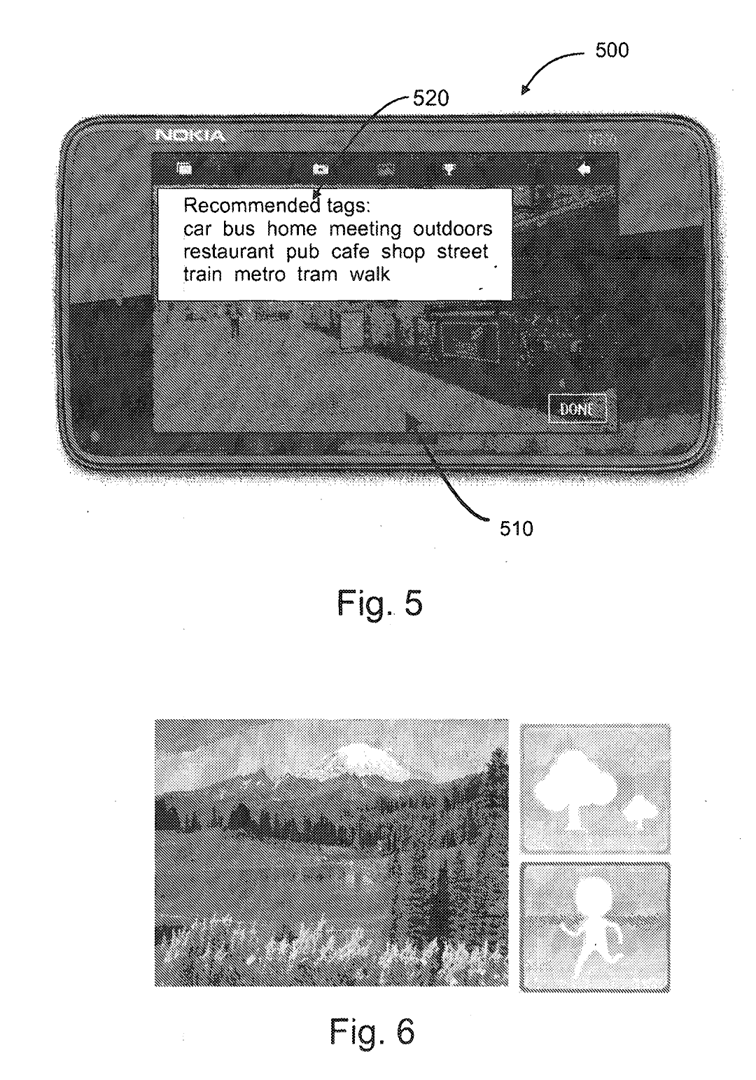

In FIG. 5 is shown a smart phone 500 displaying context tags according to an embodiment. In a display of the smart phone 500 is shown a photo 510 taken at a certain time point and on the photo 510 is also shown context tags 520 collected prior to and after the certain time point. From shown context tags 520 the user may select suitable tags 520 he/she wants to be tagged in the photo 510. The tagging system collecting and viewing the context tags 520 may also recommend some most suitable tags for the photo 510. These tags may be displayed with different shape, size or color.

It is possible to use determined media tag/tags only as metadata for media content to help searching of media content afterwards, but it is also possible to visualize some media tags, for example, as icons along media content. Media tags may be visualized, for example, on a display of an electronic device, such as mobile phone, smart phone or tablet, at the same time with the media content, which is shown in FIG. 6.

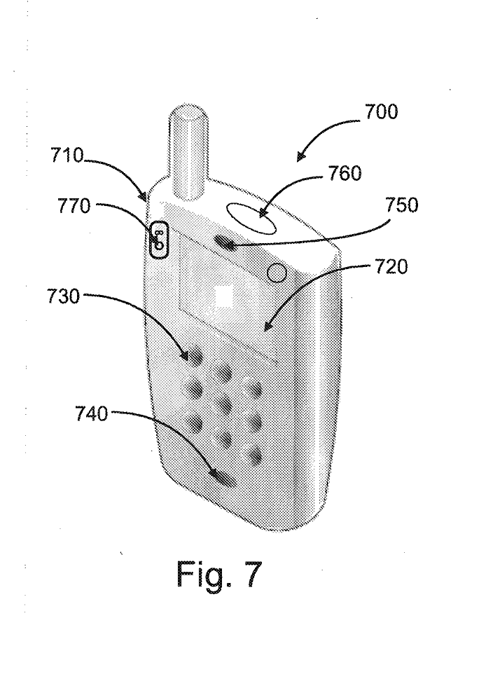

In FIG. 7 is shown a suitable apparatus for implementing embodiments of the invention according to an embodiment. The apparatus 700 may for example be a smart phone. The apparatus 700 may comprise a housing 710 for incorporating and protecting the apparatus. The apparatus 700 may further comprise a display 720, for example, a liquid crystal display or any suitable display technology suitable to display an image or video. The apparatus 700 may further comprise a keypad 730. However, in other embodiments of the invention any other suitable data or user interface mechanism may be used. The user interface may be, for example, virtual keyboard or a touch-sensitive display or voice recognition system. The apparatus may comprise a microphone 740 or any suitable audio input which may be a digital or analogue signal input. The microphone 740 may also be used for capturing or recording media content to be tagged. The apparatus 700 may further comprise an earpiece 750. However, in other embodiments of the invention it is possible that any other audio output device may be used, for example, a speaker or an analogue audio or digital audio output connection. In addition, the apparatus 700 may also comprise a rechargeable battery (not shown) or some other suitable mobile energy device such as a solar cell, fuel cell or clockwork generator. The apparatus may further comprise an infrared port 760 for short range line of sight communication to other devices. The infrared port 760 may be used for obtaining i.e. receiving media content to be tagged. In other embodiments the apparatus 700 may further comprise any suitable short range communication solution such as for example a Bluetooth or Bluetooth Smart wireless connection or a USB/firewire wired connection.

The apparatus 700 may comprise a camera 770 capable for capturing media content, images or video, for processing and tagging. In other embodiments of the invention, the apparatus may obtain (receive) the video image data for processing from another device prior to transmission and/or storage.

Without in any way limiting the scope, interpretation, or application of the claims appearing below, a technical effect of one or more of the example embodiments disclosed herein is accurate media tagging.

Embodiments of the present invention may be implemented in software, hardware, application logic or a combination of software, hardware and application logic. The software, application logic and/or hardware may reside on a mobile phone, smart phone or Internet access devices. If desired, part of the software, application logic and/or hardware may reside on a mobile phone, part of the software, application logic and/or hardware may reside on a server, and part of the software, application logic and/or hardware may reside on a camera. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 2b. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1-64. (canceled)

65. A method, comprising:
obtaining a first context recognition data and a second context recognition data, wherein said first context recognition data and said second context recognition data relate to a media content, and wherein said first context recognition data is formed prior to a time point of capturing of said media content and said second context recognition data is formed after the time point of capturing of said media content;
determining a media tag on the basis of at least said first context recognition data and said second context recognition data; and
associating said media tag with said media content.

66. A method according to claim 65, wherein said first context recognition data comprise at least first type of context tags that are obtained from a context source point prior to capturing of said media content.

67. A method according to claim 65, wherein said second context recognition data comprise at least first type of context tags that are obtained from a context source after capturing of said media content.

68. A method according to claim 65, wherein said first and second context recognition data comprise at least first and second types of context tags that are obtained from different context sources.

69. A method according to claim 66, wherein first type of context tags are obtained at:
at least one time point prior to capturing of said media content;
at least one time point after capturing of said media content; or
at a span prior to capturing of said media content.

70. A method according to claim 66, wherein first type of context tags are obtained at a span after capturing of said media content.

71. A method according to claim 68, wherein obtained first and second type of context tags are formed into words.

72. A method according to claim 65, wherein said media tag is determined:
by choosing the most common context tag in said first and second context recognition data;
by choosing the context tag from first and second context recognition data that is obtained from context source at the time point that is closest to the time point of capturing of said media content;
on the basis of weighting of context tags; or
on the basis of telescopic tagging

73. A method according to claim 72, wherein said weighting is done by assigning a weight for a context tag on the basis of distance of a time point of obtaining said context tag from the time point of capturing of said media content.

74. An apparatus comprising at least one processor, at least one memory including computer program code for one or more program units, the at least one memory and the computer program code configured to, with the processor, cause the apparatus to perform at least the following:
obtain first context recognition data and second context recognition data, wherein said first context recognition data and said second context recognition data relate to a media content, and wherein said first context recognition data is formed prior to a time point of capturing of said media content and said second context recognition data is formed after the time point of capturing of said media content;
determine a media tag on the basis of at least said first context recognition data and said second context recognition data; and
associate said media tag with said media content.

75. An apparatus according to claim 74, wherein said first context recognition data comprise at least first type of context tags that are obtained from a context source point prior to capturing of said media content.

76. An apparatus according to claim 74, wherein said second context recognition data comprise at least first type of context tags that are obtained from a context source after capturing of said media content.

77. An apparatus according to claim 74, wherein said first and second context recognition data comprise at least first and second types of context tags that are obtained from different context sources.

78. An apparatus according to claim 75, wherein first type of context tags are obtained at:
at least one time point prior to capturing of said media content;
at least one time point after capturing of said media content; or
a span prior to capturing of said media content.

79. An apparatus according to claim 75, wherein first type of context tags are obtained at a span after capturing of said media content.

80. An apparatus according to claim 77, wherein obtained first and second type of context tags are formed into words.

81. An apparatus according to claim 74, wherein said media tag is determined:
by choosing the most common context tag in said first and second context recognition;
by choosing the context tag from first and second context recognition data that is obtained from context source at the time point that is closest to the time point of capturing of said media content;
on the basis of weighting of context tags; or
on the basis of telescopic tagging.

82. An apparatus according to claim 81, wherein said weighting is done by assigning a weight for a context tag on the basis of distance of a time point of obtaining said context tag from the time point of capturing of said media content.

83. A computer program comprising one or more instructions which, when executed by one or more processors, cause an apparatus to perform:
obtain a first context recognition data and a second context recognition data, wherein said first context recognition data and said second context recognition data relate to a media content, and wherein said first context recognition data is formed prior to a time point of capturing of said media content and said second context recognition data is formed after the time point of capturing of said media content;
determine a media tag on the basis of at least said first context recognition data and said second context recognition data; and
associate said media tag with said media content.

84. A computer program according to claim 83, wherein said first context recognition data comprise at least first type of context tags that are obtained from a context source point prior to capturing of said media content.

85. A computer program according to claim 84, wherein said second context recognition data comprise at least first type of context tags that are obtained from a context source after capturing of said media content.
